(19) United States
(12) Patent Application Publication
(10) Pub. No.: US 2017/0373339 A1
(43) Pub. Date: Dec. 28, 2017

(54) SECONDARY BATTERY AND CYLINDRICAL LITHIUM SECONDARY BATTERY

(71) Applicant: EIG LTD., Cheonan-si (KR)

(72) Inventors: Seong Gyu Cho, Busan (KR); Hyung Ki Kang, Cheonan-si (KR); Kyung II Kim, Cheonan-si (KR); Myeong Seok Kim, Cheonan-si (KR); Young Bae Roh, Yongin-si (KR)

(73) Assignee: EIG LTD., Cheonan-si (KR)

(21) Appl. No.: 15/699,463

(22) Filed: Sep. 8, 2017

Related U.S. Application Data
(63) Continuation of application No. PCT/KR2015/007176, filed on Jul. 10, 2015.

(30) Foreign Application Priority Data
Mar. 9, 2015 (KR) 10-2015-0032637

(51) Int. Cl. H01M 10/04; H01M 4/80; H01M 10/052; H01M 4/485; H01M 4/02

(52) U.S. Cl. CPC H01M 10/0477; H01M 10/052; H01M 4/485; H01M 4/80; H01M 2004/028

(57) ABSTRACT

A secondary battery or a cylindrical lithium secondary battery is generally described. An exemplary lithium secondary battery module includes: an electrode assembly; a first current collector plate; and a second current collector plate. The electrode assembly is formed by winding an anode plate having a first uncoated region formed on one side, a cathode plate having a second uncoated region formed on the other side, and a separator disposed between the anode plate and the cathode plate. The first current collector plate is electrically connected to the first uncoated region through direct contact therewith, and the second current collector plate is electrically connected to the second uncoated region through direct contact therewith. The second uncoated region of the cathode plate and the first uncoated region of the anode plate are formed of the same metal material.

### CROSS-REFERENCE TO RELATED APPLICATIONS

This application is a continuation application of Patent Cooperation Treaty (PCT) international application Serial No. PCT/KR2015/007176, filed on July 10, 2015, and which designates the United States, which claims priority to Korean Patent Application Serial No. 10-2015-0032637, filed on Mar. 9, 2015. The entire contents of PCT international application Ser. No. PCT/KR2015/007176, and Korean Patent Application Serial No. 10-2015-0032637 are hereby incorporated by reference.

### TECHNICAL FIELD

The present disclosure relates to a secondary battery and a cylindrical lithium secondary battery.

### BACKGROUND

Unless otherwise indicated herein, the materials described in this section are not prior art to the claims in this application and are not admitted as prior art by inclusion in this section.

Secondary batteries (rechargeable batteries) typically refer to batteries that are rechargeable and are widely used in compact electronic devices such as mobile phones, notebook computers, and camcorders and may also be used as batteries in vehicles such as automobiles. Particularly, a lithium secondary battery generally has high performance and high stability, and is manufactured from a material selected depending on required characteristics, e.g., the lifespan, charge/discharge capacity, charge/discharge rate, temperature characteristic, stability of the battery.

A secondary battery includes an anode, a cathode, and a separator arranged between the anode and the cathode to insulate the anode and the cathode from each other. The secondary battery may have various shapes such as cylindrical shape or a square shape. Each of the anode, the separator, and the cathode in the secondary battery has a plate shape, and an electrode assembly typically referred to as a jelly roll can be formed by stacking the anode, the separator, and the cathode and winding them together. Then, the wound electrode assembly is built in a case of the secondary battery.

The secondary battery may further include a cap assembly, and the cap assembly transfers a current generated from the anode and the cathode of the electrode assembly to an electrode terminal formed outside the secondary battery. In an example, a conductive tap is attached to an uncoated region in each of an anode plate and a cathode plate in order to collect a current generated from the anode plate and the cathode plate. In another example, a current collector plate having a larger area than the tap may be used in order for the secondary battery to have operating characteristics, e.g., high charge/discharge amount per unit time, of a large capacity battery.

### SUMMARY

In an exemplary embodiment of the present disclosure, an exemplary secondary battery is disclosed. The exemplary secondary battery may include an electrode assembly, a first current collector plate, and a second current collector plate. The electrode assembly may be formed by winding an anode plate, a cathode plate, and a separator disposed between the anode plate and the cathode plate. The anode plate may have a first uncoated region formed on one side of the electrode assembly and the cathode plate may have a second uncoated region formed on the other side of the electrode assembly. The first current collector plate may be directly contacted with the first uncoated region of the anode plate to be electrically connected, and the second current collector plate may be directly contracted with the second uncoated region of the cathode plate to be electrically connected. The second uncoated region of the cathode plate and the first uncoated region of the anode plate may be formed of the same metal material.

In an exemplary embodiment, the cathode plate may include a material with a redox operating range of 1.0 V or more. The cathode plate may include lithium titanium oxide (LTO) as a cathode material.

In an exemplary embodiment, the exemplary secondary battery may further include a first insulator covering the first uncoated region and the first current collector plate and a second insulator covering the second uncoated region and the second current collector plate.

Further, the first current collector plate and the second current collector plate may be laser welded to the first uncoated region and the second uncoated region, respectively. The first current collector plate may have a protruding portion which is a weld point with the first uncoated region and the second current collector plate may have a protruding portion which is a weld point with the second uncoated region.

The first current collector plate may be pressed to be contacted across the first uncoated region and the second current collector plate may be pressed to be contacted across the second uncoated region.

The first uncoated region of the anode plate, the second uncoated region, the first current collector plate, and the second current collector plate may be formed of the same material. In some examples, the second uncoated region of the cathode plate may be formed of aluminum.

In another exemplary embodiment, an exemplary secondary battery may include: an electrode assembly formed by winding an anode plate, a cathode plate, and a separator disposed between the anode plate and the cathode plate; and two or more current collector plates directly contacted with the uncoated region of the anode plate or the cathode plate to be electrically connected. In this exemplary embodiment, the two or more current collector plates may be pressed to be contacted across the uncoated region of the anode plate or the cathode plate.

In yet another exemplary embodiment, an exemplary secondary battery may include: an electrode assembly formed by winding an anode plate, a cathode plate, and a separator disposed between the anode plate and the cathode plate; and two or more current collector plates directly contacted with an uncoated region of the anode plate or the cathode plate to be electrically connected . In this exemplary embodiment, the uncoated region of the anode plate or the cathode plate may be an aluminum-uncoated region and each of the two or more current collector plates may be an aluminum current collector plate. The cathode plate may include a material with a redox operating range of 1.0 V or more, and may include, for example, LTO.

In an exemplary embodiment of the present disclosure, an exemplary cylindrical lithium secondary battery is disclosed. The exemplary cylindrical lithium secondary battery may include an electrode assembly and a set of current collector plates. The electrode assembly may include an anode plate, a cathode plate, and a separator disposed between the anode plate and the cathode plate and may be formed by winding the anode plate, the cathode plate, and the separator. Further, the anode plate may have an aluminum-uncoated region formed on one side of the electrode assembly and the cathode plate may have an aluminum-uncoated region formed on the other side of the electrode assembly.

The set of current collector plates may include two or more aluminum current collector plates. In this exemplary embodiment, the anode plate may have an aluminum-uncoated region formed on one side of the electrode assembly and the cathode plate may have an aluminum-uncoated region formed on the other side of the electrode assembly. The two or more aluminum current collector plates may be directly contacted with the uncoated region of the anode plate or the cathode plate to be electrically connected. In this exemplary embodiment, the two or more aluminum current collector plates may be laser welded to the aluminum-uncoated region of the anode plate or the cathode plate. Further, the cathode plate may include a material with a redox operating range of 1.0 V or more as a cathode material, and may include, for example, LTO.

The above-described summary is provided for illustration purposes only and does not intend to limit in any ways. In addition to the exemplary embodiments, examples, and features described above, additional embodiments, examples, and features will become apparent by referring to the drawings and the following detailed description.

### BRIEF DESCRIPTION OF THE DRAWINGS

The foregoing features and other features of the present disclosure will be sufficiently apparent from the following descriptions and the appended claims with reference to the accompanying drawings. These drawings merely illustrate several exemplary embodiments in accordance with the present disclosure. Therefore, they should not be understood as limiting the present disclosure. The present disclosure will be described in more detail with reference to the accompanying drawings.

FIG. 1 schematically illustrates a cross-section of a part of an exemplary secondary battery arranged in accordance with at least some exemplary embodiments of the present disclosure;

FIG. 2 schematically illustrates a cross-section of a part of another exemplary secondary battery arranged in accordance with at least some exemplary embodiments of the present disclosure;

FIG. 3 illustrates an exemplary current collector plate and an exemplary insulator arrange in accordance with at least some exemplary embodiments of the present disclosure;

FIG. 4A and FIG. 4B are graphs showing charging aspects of an exemplary secondary battery in accordance with at least some exemplary embodiments of the present disclosure; and

FIG. 5A and FIG. 5B are graphs showing discharging aspects of an exemplary secondary battery in accordance with at least some exemplary embodiments of the present disclosure.

### BEST MODE FOR CARRYING OUT THE INVENTION

In the following detailed description, reference is made to the accompanying drawings, which constitutes a part of the present disclosure. In the drawings, similar symbols generally identify similar components unless context dictates otherwise. The illustrative embodiments described in the detailed description, drawings, and claims are not meant to be limiting. Other embodiments may be used and other changes may be made, without departing from the spirit and scope of the subject matter presented herein. It will be readily understood that the aspects of the present disclosure, as generally described herein and illustrated in the drawings, can be arranged, substituted, combined, separated, and designed in a wide variety of different configurations, all of which are implicitly contemplated herein.

The present disclosure generally relates to a secondary battery and a cylindrical lithium secondary battery.

In brief, the present disclosure relates to a secondary battery and a cylindrical lithium secondary battery. A secondary battery according to an exemplary embodiment of the present disclosure may include an electrode assembly formed by winding an anode plate, a cathode plate, and a separator disposed between the anode plate and the cathode plate, a first current collector plate, and a second current collector plate. The anode plate may have a first uncoated region formed on one side of the electrode assembly and the cathode plate may have a second uncoated region formed on the other side of the electrode assembly. The first current collector plate may be directly contacted with the first uncoated region to be electrically connected and the second current collector plate may be directly contacted with the second uncoated region to be electrically connected. In an example, the first current collector plate may be laser welded to the first uncoated region and the second current collector plate may be laser welded to the second uncoated region. The second uncoated region of the cathode plate may be formed of the same material as the first uncoated region, and in some examples, the first uncoated region, the second uncoated region, the first current collector plate, and the second current collector plate may be formed of the same material thereby reducing an internal resistance at a welded part. For example, at least one of the first uncoated region and the second uncoated region may be formed of a metal material such as aluminum. Further, the cathode plate may include a material with a redox operating range of 1.0 V or more. For example, the cathode plate may include lithium titanium oxide (LTO) as a cathode material.

In some examples, the first current collector plate may be pressed to be contacted across the one side of the electrode assembly. Similarly, the second current collector plate may be pressed to be contacted across the other side of the electrode assembly.

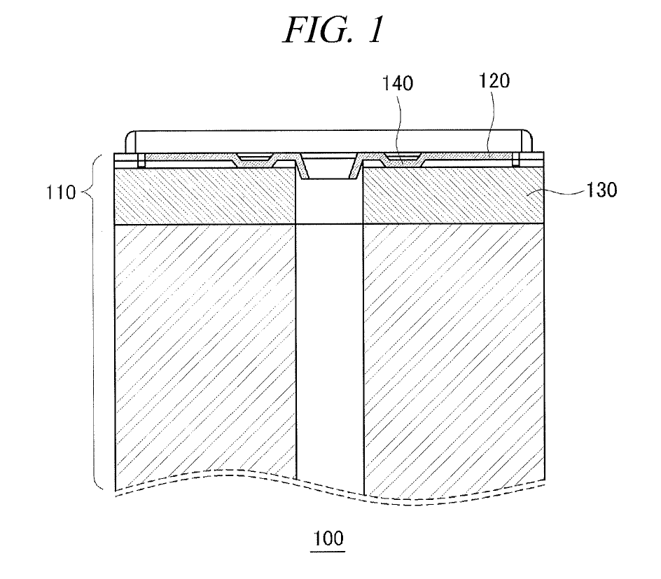

FIG. 1 schematically illustrates a cross-section of a part of an exemplary secondary battery arranged in accordance with at least some exemplary embodiments of the present disclosure. An exemplary secondary battery 100 may have various shapes, for example, a cylindrical shape. The exemplary secondary battery 100 may include an electrode assembly 110 and a current collector plate 120. The electrode assembly 110 may include an anode plate, a cathode plate, and a separator disposed between the anode plate and the cathode plate which are not illustrated in FIG. 1. Each of the anode plate and the cathode plate includes an uncoated region which is not coated with an active material and a coated region which is coated with the active material in a current collector. The uncoated region is formed on one end of each of the anode plate and the cathode plate.

In some examples, the uncoated region of the anode plate may be located on one end of the electrode assembly 110 and the uncoated region of the cathode plate may be located on the other end of the electrode assembly 110, and the separator may be disposed between the anode plate and the cathode plate in order to avoid contacting between the anode plate and the cathode plate and then, the electrode assembly 110 may be formed by winding the arranged anode, separator, and cathode. In FIG. 1, a reference numeral 130 denotes an uncoated region of the anode plate or cathode plate formed on one side of the wound electrode assembly 110, and an uncoated region of the cathode plate or anode plate disposed opposite to the uncoated region 130 in the electrode assembly 110 is omitted from FIG. 1 for clarity of explanation.

A current generated by a redox occurring in the coated region of the electrode assembly 110 may be transferred to the uncoated region 130, and the current collector plate 120 may be directly contacted with the uncoated region to be electrically connected such that the transferred current can be collected by the current collector plate 120 electrically connected to the uncoated region 130. In some examples, the current collector plate 120 may be laser welded to the uncoated region 130 by using a laser welding technique. The current collector plate 120 may have a protruding portion 140 which is a weld point with the uncoated region 130. If the laser welding technique is used, a laser is applied to the protruding portion 140 and heat from the laser is transferred to the uncoated region 130 through the protruding portion 140, and, thus, the protruding portion 140 can be welded to the uncoated region 130.

In general, materials of the uncoated regions of the anode plate and the cathode plate may be selected in consideration of stability in terms of electrochemical potential change and oxidation-resistance or reduction-resistance. In an example of a lithium secondary battery, typically, the uncoated region of the anode plate is formed using aluminum in consideration of oxidation resistance and the uncoated region of the cathode plate is formed using copper in consideration of reduction oxidation. However, the melting point of aluminum is about 650° C. and the melting point of copper is about 1600° C., and, thus, if a welding technique such as the laser welding technique is used, when the cathode plate formed of copper is welded, the separator of the electrode assembly 110 may be melted by heat.

In the secondary battery 100 according to the present disclosure, the uncoated region 130 of the cathode plate may be formed of the same metal material as the uncoated region 130 of the anode plate. Since the current collector plate 120 and the uncoated region 130 are formed of the same metal material, an internal resistance caused by connection can be reduced. In some examples, the uncoated regions 130 of the anode plate and the cathode plate may be formed of aluminum in order to increase the efficiency in welding of the uncoated regions 130 of the anode plate and the cathode plate and the current collector plate 120 and avoid melting of the separator of the electrode assembly 110.

If the uncoated region 130 of the cathode plate is selected to be formed of the same metal material as the uncoated region of the anode plate, an electrode material of the cathode plate may be selected in consideration of the selected metal material. In an example, the uncoated region 130 of the cathode plate may be formed of aluminum and a stable redox voltage range of aluminum is from about 1.0 V to about 4.5 V. In some examples, the cathode plate of the electrode assembly 110 may include a material with a redox operating range of 1.0 V or more. For example, the cathode plate may include lithium titanium oxide (LTO), and LTO may stably undergo an electrochemical redox reaction at about 1.5 V or more. The coated region of the cathode may include an electrode material including LTO.

In an additional example, all of the uncoated regions 130 of the anode plate and the cathode plate and the current collector plates 120 respectively welded to the uncoated regions 130 of the anode plate and the cathode plate may be formed of the same metal material. For example, the uncoated regions 130 of the anode plate and the cathode plate and the current collector plates 120 may be formed of aluminum.

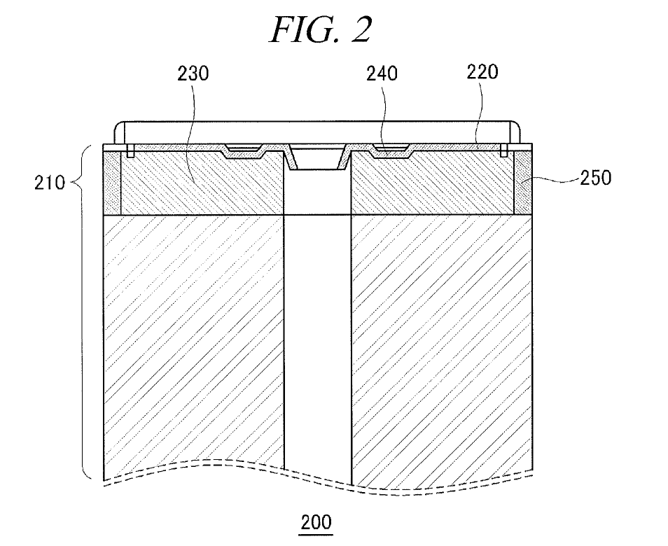

FIG. 2 schematically illustrates a cross-section of a part of another exemplary secondary battery arranged in accordance with at least some exemplary embodiments of the present disclosure. An exemplary secondary battery 200 may have various shapes, for example, a cylindrical shape. The exemplary secondary battery 200 may include an electrode assembly 210, a current collector plate 220, and an insulator 250. As described with reference to FIG. 1, the electrode assembly 210 may include an anode plate, a cathode plate, and a separator disposed between the anode plate and the cathode plate which are not illustrated in FIG. 2. Each of the anode plate and the cathode plate includes an uncoated region which is not coated with an active material and a coated region which is coated with the active material in a current collector. The uncoated region is formed on one end of each of the anode plate and the cathode plate.

In some examples, the uncoated region of the anode plate may be located on one end of the electrode assembly 210 and the uncoated region of the cathode plate may be located on the other end of the electrode assembly 210, and the separator may be disposed between the anode plate and the cathode plate in order to avoid contacting between the anode plate and the cathode plate and then, the electrode assembly 210 may be formed by winding the arranged anode, separator, and cathode.

In FIG. 2, the current collector plate 220 may be contacted across the uncoated region 230. In some examples, the current collector plate 220 may be pressed to be brought into close contact with the uncoated region and can thus be contacted across the uncoated region 230. The current collector plate 220 may have a protruding portion 240 which is a weld point with the uncoated region 230. If the laser welding technique is used, a laser is applied to the protruding portion 240 and heat from the laser is transferred to the uncoated region 230 through the protruding portion 240, and, thus, the protruding portion 240 can be welded to the uncoated region 230.

The insulator 250 may be configured to cover all of the uncoated region 230 and the current collector plate 220 in contact with the uncoated region 230 in order to electrically insulate the uncoated region 230 from a case (not illustrated) of the secondary battery 200. In some examples, a contact area between the current collector plate 220 and the uncoated region 230 can be adjusted by pressing the insulator 250, and a protruding length of the protruding portion 240 can also be adjusted. As a result, by adjusting the contact area between the current collector plate 220 and the uncoated region 230 and the protruding length of the protruding portion 240, it is possible to avoid melting of the separator caused by welding heat such as heat from a laser applied to the protruding portion 240.

The uncoated region 230 of the cathode plate of the secondary battery 200 according to the present disclosure may be formed of the same metal material as the uncoated region 230 of the anode plate. Since the current collector plate 220 and the uncoated region 230 are formed of the same metal material, an internal resistance caused by connection can be reduced. In some examples, the uncoated regions 230 of the anode plate and the cathode plate may be formed of aluminum in order to increase the efficiency in welding of the current collector plate 220 and the uncoated regions 230 of the anode plate and the cathode plate and avoid melting of the separator of the electrode assembly 210. The melting point of aluminum is about 650° C., and, thus, even if a welding technique using heat such as the laser welding technique is used, it is possible to avoid melting of the separator of the electrode assembly 210 by heat.

If the uncoated region 230 of the cathode plate is selected to be formed of the same metal material as the uncoated region of the anode plate, an electrode material of the cathode plate may be selected in consideration of the selected metal material. In an example, the uncoated region 230 of the cathode plate may be formed of aluminum and a stable redox voltage range of aluminum is from about 1.0 V to about 4.5 V. In some examples, the cathode plate of the electrode assembly 210 may include a material with a redox operating range of 1.0 V or more. For example, the cathode plate may include LTO, and LTO may stably undergo an electrochemical redox reaction at about 1.5 V or more.

In an additional example, all of the uncoated regions 230 of the anode plate and the cathode plate and the current collector plates 220 respectively welded to the uncoated regions 230 of the anode plate and the cathode plate may be formed of the same metal material. For example, all of the uncoated regions 230 of the anode plate and the cathode plate and the current collector plates 220 may be formed of aluminum.

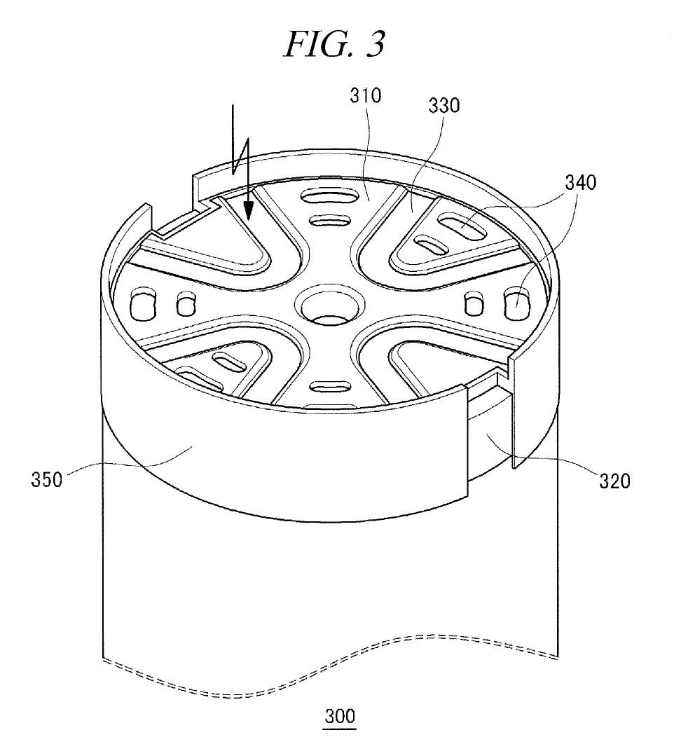

FIG. 3 illustrates an exemplary current colleting plate and an exemplary insulator arrange in accordance with at least some exemplary embodiments of the present disclosure. In some examples, a current collector plate 310 may be disposed on an upper part of an uncoated region 320. The current collector plate 310 may include a protruding portion 330 and one or more holes 340 as electrolyte injection holes. As described above with reference to FIG. 1 and FIG. 2, the protruding portion 330 may be a weld point with the uncoated region 320. In some examples, as indicated by an arrow in FIG. 3, a laser may be applied to an upper part of the protruding portion 330 to weld the protruding portion 330 to the uncoated region 320.

An insulator 350 may be configured to cover the current collector plate 310 and the uncoated region 320 as illustrated in FIG. 3. Further, a pressure with a predetermined intensity in a predetermined direction may be applied from the outside of the insulator 350 in order that the current collector plate 310 contacts across the uncoated region 320 and a shape of the protruding portion 330 is adjusted, as described above with reference to FIG. 2.

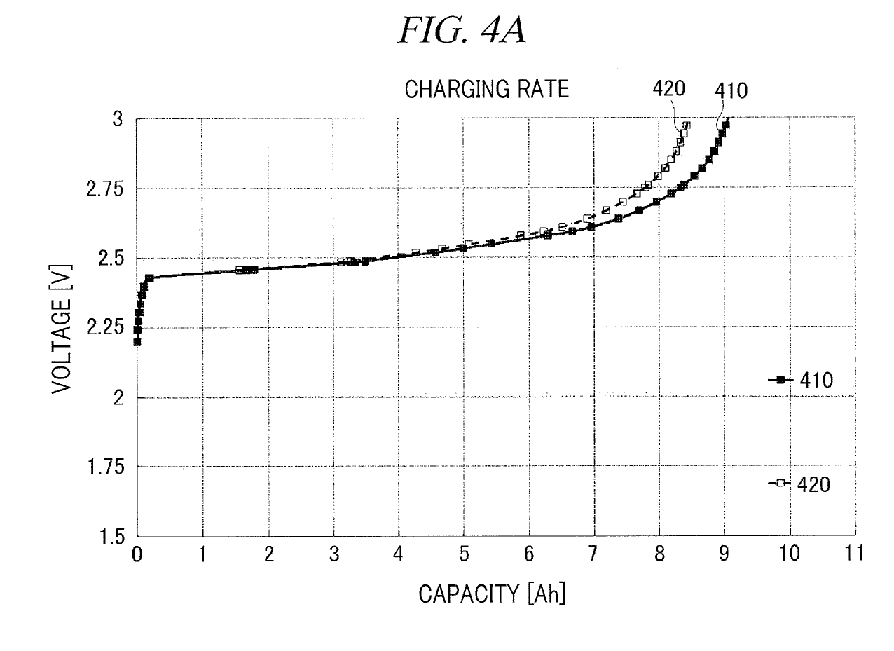

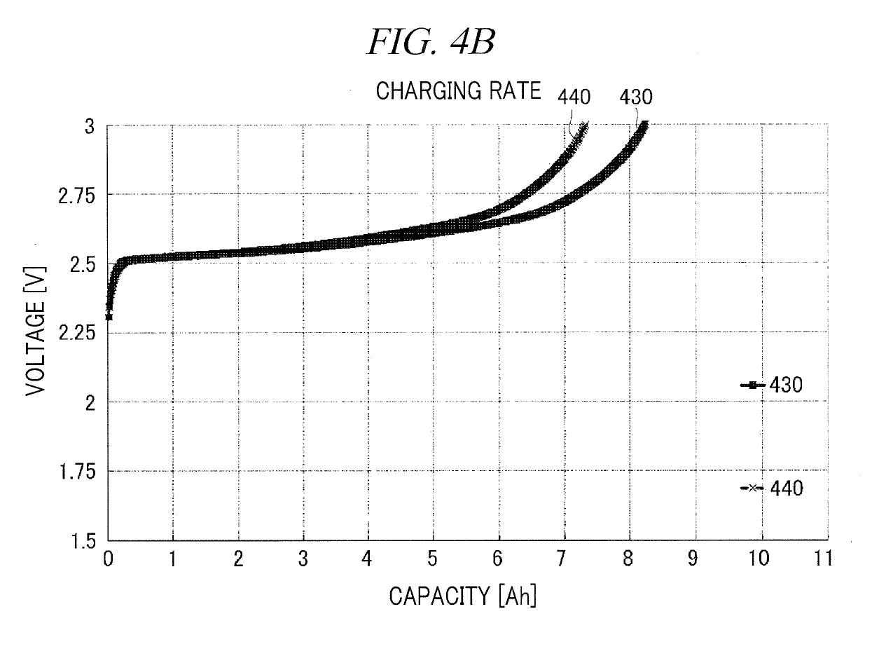

FIG. 4A and FIG. 4B are graphs showing charging aspects of an exemplary secondary battery in accordance with at least some exemplary embodiments of the present disclosure. FIG. 4A and FIG. 4B show charging aspects of a secondary battery depending on a C-rate, and specifically, FIG. 4A shows a charging aspect in an environment where a charging C-rate is 10 C and FIG. 4B shows a charging aspect in an environment where a charging C-rate is 20 C. In FIG. 4A and FIG. 4B, a vertical axis represents an internal voltage of the secondary battery and a horizontal axis represents the amount of electric charges charged into the secondary battery per unit time.

In FIG. 4A, a first curve 410 shows a charging aspect of the secondary battery in an exemplary 10 C environment in accordance with at least some exemplary embodiments of the present disclosure. A second curve 420 shows a charging aspect in the 10 C environment in the case where a material for an uncoated region of an anode and a material for an uncoated region of a cathode are selected in consideration of stability in terms of electrochemical potential change, oxidation resistance, and reduction resistance, and, thus, the uncoated region of the anode is different from the uncoated region of the cathode. Table 1 shows some values measured in an exemplary test regarding FIG. 4A. As shown in FIG. 4A and Table 1, it can be seen that the secondary battery according to the present disclosure is stably charged with electric charges even with a relatively high charge capacity.

TABLE 1
C-rate = 10 C

| | Capacity [Ah] | |
|---|---|---|
| Voltage [V] | Curve 410 | Curve 420 |
| 2.2 | 0.003 | 0.002805 |
| 2.2436 | 0.011 | 0.010285 |
| 2.2732 | 0.019 | 0.017765 |
| 2.3059 | 0.033 | 0.030855 |
| 2.3364 | 0.05 | 0.04675 |
| 2.3673 | 0.075 | 0.070125 |
| 2.3985 | 0.117 | 0.109395 |
| 2.4286 | 0.197 | 0.184195 |
| 2.4572 | 1.667 | 1.558645 |
| 2.4586 | 1.786 | 1.66991 |
| 2.485 | 3.333 | 3.116355 |
| 2.4887 | 3.492 | 3.26502 |
| 2.5188 | 4.57 | 4.27295 |
| 2.5334 | 5 | 4.675 |
| 2.5488 | 5.433 | 5.079855 |
| 2.5789 | 6.289 | 5.880215 |
| 2.5938 | 6.667 | 6.233645 |
| 2.609 | 6.964 | 6.51134 |
| 2.6391 | 7.383 | 6.903105 |
| 2.6691 | 7.697 | 7.196695 |
| 2.6992 | 7.964 | 7.44634 |
| 2.7293 | 8.197 | 7.664195 |
| 2.7501 | 8.333 | 7.791355 |
| 2.7599 | 8.389 | 7.843175 |
| 2.7899 | 8.539 | 7.983965 |
| 2.82 | 8.661 | 8.098035 |
| 2.8502 | 8.761 | 8.191535 |
| 2.8807 | 8.844 | 8.26914 |
| 2.9115 | 8.914 | 8.33459 |
| 2.9426 | 8.972 | 8.38882 |
| 2.9731 | 9.022 | 8.43557 |

In FIG. 4B, a third curve 430 shows a charging aspect of the secondary battery in an exemplary 20 C environment in accordance with at least some exemplary embodiments of the present disclosure. A fourth curve 440 shows a charging aspect in the 20 C environment in the case where a material for the uncoated region of the anode and a material for the uncoated region of the cathode are selected in consideration of stability in terms of electrochemical potential change, oxidation resistance, and reduction resistance, and, thus, the uncoated region of the anode is different from the uncoated region of the cathode. Table 2 shows some values measured in an exemplary test regarding FIG. 4B. As shown in FIG. 4B and Table 2, it can be seen that the secondary battery according to the present disclosure is stably charged with electric charges even with a relatively high charge capacity.

TABLE 2
C-rate = 20 C

| | Capacity [Ah] | |
|---|---|---|
| Voltage [V] | Curve 430 | Curve 440 |
| 2.5228 | 0.889 | 0.79121 |
| 2.5258 | 1.111 | 0.98879 |
| 2.5286 | 1.333 | 1.18637 |
| 2.5315 | 1.556 | 1.38484 |
| 2.5344 | 1.778 | 1.58242 |
| 2.5375 | 2 | 1.78 |
| 2.5407 | 2.222 | 1.97758 |
| 2.5443 | 2.445 | 2.17605 |
| 2.5481 | 2.667 | 2.37363 |
| 2.5523 | 2.889 | 2.57121 |
| 2.5566 | 3.111 | 2.76879 |
| 2.5614 | 3.333 | 2.96637 |
| 2.5665 | 3.556 | 3.16484 |
| 2.5721 | 3.778 | 3.36242 |
| 2.5779 | 4 | 3.56 |
| 2.5842 | 4.222 | 3.75758 |
| 2.5908 | 4.445 | 3.95605 |
| 2.5979 | 4.667 | 4.15363 |
| 2.6052 | 4.889 | 4.35121 |
| 2.613 | 5.111 | 4.54879 |
| 2.6209 | 5.333 | 4.74637 |
| 2.6289 | 5.556 | 4.94484 |
| 2.6374 | 5.778 | 5.14242 |
| 2.6468 | 6 | 5.34 |
| 2.6574 | 6.222 | 5.53758 |
| 2.6705 | 6.445 | 5.73605 |
| 2.7356 | 7.111 | 6.32879 |
| 2.7693 | 7.333 | 6.52637 |
| 2.8082 | 7.556 | 6.72484 |
| 2.8542 | 7.778 | 6.92242 |
| 2.9119 | 8 | 7.12 |

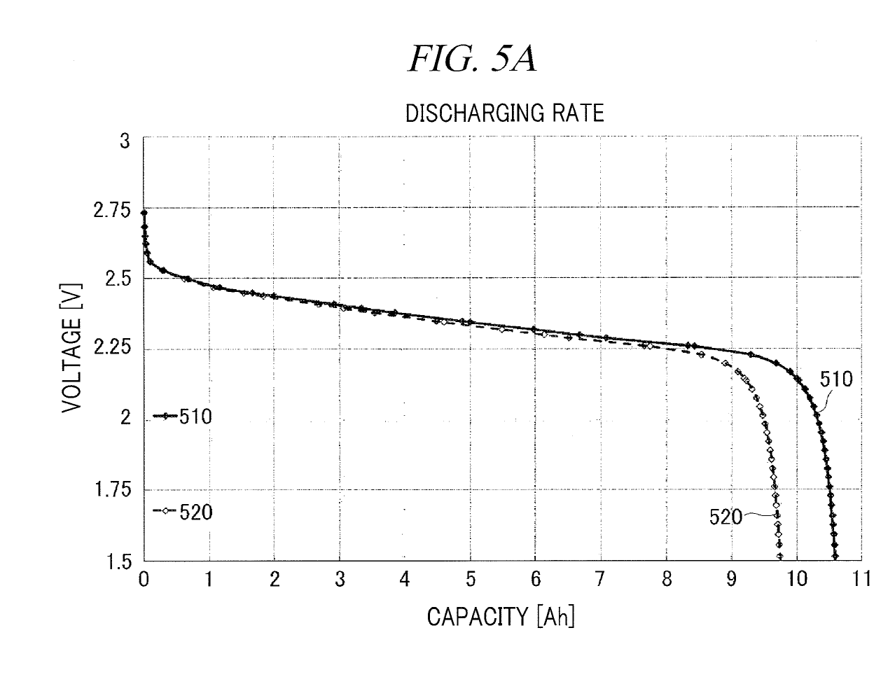

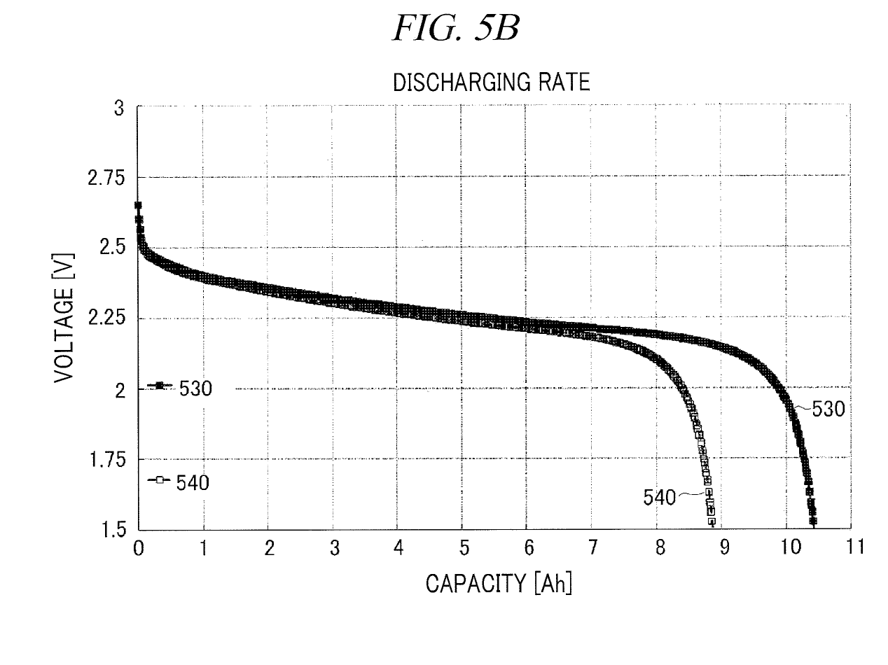

FIG. 5A and FIG. 5B are graphs showing discharging aspects of an exemplary secondary battery in accordance with at least some exemplary embodiments of the present disclosure. FIG. 5A and FIG. 5B show discharging aspects of a secondary battery depending on a C-rate, and specifically, FIG. 5A shows a discharging aspect in an environment where a charging C-rate is 10 C and FIG. 5B shows a discharging aspect in an environment where a charging C-rate is 20 C. In FIG. 5A and FIG. 5B, a vertical axis represents an internal voltage of the secondary battery and a horizontal axis represents the amount of electric charges discharged from the secondary battery per unit time.

In FIG. 5A, a first curve 510 shows a discharging aspect of the secondary battery in an exemplary 10 C environment in accordance with at least some exemplary embodiments of the present disclosure. A second curve 520 shows a discharging aspect in the 10 C environment in the case where a material for the uncoated region of the anode and a material for the uncoated region of the cathode are selected in consideration of stability in terms of electrochemical potential change, oxidation resistance, and reduction resistance, and, thus, the uncoated region of the anode is different from the uncoated region of the cathode. Table 3 shows some values measured in an exemplary test regarding FIG. 5A. As shown in FIG. 5A and Table 3, it can be seen that the secondary battery according to the present disclosure stably discharges electric charges even with a relatively high discharge capacity.

TABLE 3
C-rate = 10 C

| | Capacity [Ah] | |
|---|---|---|
| Voltage [V] | Curve 510 | Curve 520 |
| 2.6836 | 0.011 | 0.01012 |
| 2.6228 | 0.031 | 0.02852 |
| 2.5904 | 0.05 | 0.046 |
| 2.5994 | 0.097 | 0.08924 |
| 2.499 | 0.672 | 0.61824 |
| 2.4689 | 1.161 | 1.06812 |
| 2.449 | 1.667 | 1.53364 |
| 2.3949 | 3.333 | 3.06636 |
| 2.3786 | 3.847 | 3.53924 |
| 2.3485 | 4.878 | 4.48776 |
| 2.345 | 5 | 4.6 |
| 2.3185 | 5.967 | 5.48964 |
| 2.2995 | 6.667 | 6.13364 |
| 2.1982 | 9.678 | 8.90376 |
| 2.1676 | 9.892 | 9.10064 |
| 2.1444 | 10 | 9.2 |
| 2.1372 | 10.028 | 9.22576 |
| 2.1064 | 10.125 | 9.315 |
| 2.0762 | 10.197 | 9.38124 |
| 1.921 | 10.403 | 9.57076 |
| 1.8891 | 10.428 | 9.59376 |
| 1.8568 | 10.45 | 9.614 |
| 1.8249 | 10.469 | 9.63148 |
| 1.7944 | 10.486 | 9.64712 |
| 1.6956 | 10.53 | 9.6876 |
| 1.6586 | 10.544 | 9.70048 |
| 1.6267 | 10.555 | 9.7106 |
| 1.5923 | 10.567 | 9.72164 |
| 1.4994 | 10.593 | 9.74556 |

In FIG. 5B, a third curve 530 shows a discharging aspect of the secondary battery in an exemplary 20 C environment in accordance with at least some exemplary embodiments of the present disclosure. A fourth curve 540 shows a discharging aspect in the 20 C environment in the case where a material for the uncoated region of the anode and a material for the uncoated region of the cathode are selected in consideration of stability in terms of electrochemical potential change, oxidation resistance, and reduction resistance, and, thus, the uncoated region of the anode is different from the uncoated region of the cathode. Table 4 shows some values measured in an exemplary test regarding FIG. 5B. As shown in FIG. 5B and Table 4, it can be seen that the secondary battery according to the present disclosure stably discharges electric charges even with a relatively high discharge capacity.

TABLE 4
C-rate = 20 C

| | Capacity [Ah] | |
|---|---|---|
| Voltage [V] | Curve 530 | Curve 540 |
| 2.4733 | 0.194 | 0.1649 |
| 2.4356 | 0.528 | 0.4488 |
| 2.4084 | 0.861 | 0.73185 |
| 2.3898 | 1.194 | 1.0149 |
| 2.3766 | 1.5 | 1.275 |
| 2.3633 | 1.833 | 1.55805 |
| 2.3513 | 2.139 | 1.81815 |
| 2.3385 | 2.472 | 2.1012 |
| 2.3263 | 2.805 | 2.38425 |
| 2.3156 | 3.111 | 2.64435 |
| 2.3046 | 3.444 | 2.9274 |
| 2.2951 | 3.75 | 3.1875 |
| 2.2849 | 4.083 | 3.47055 |
| 2.2493 | 5.389 | 4.58065 |
| 2.2409 | 5.722 | 4.8637 |
| 2.2334 | 6.028 | 5.1238 |
| 2.2258 | 6.361 | 5.40685 |
| 2.2043 | 7.361 | 6.25685 |
| 2.1965 | 7.694 | 6.5399 |
| 2.1883 | 8 | 6.8 |
| 2.1796 | 8.278 | 7.0363 |
| 2.1709 | 8.5 | 7.225 |
| 2.159 | 8.75 | 7.4375 |
| 2.1432 | 9 | 7.65 |
| 2.1185 | 9.278 | 7.8863 |
| 2.1153 | 9.305 | 7.90925 |
| 2.07 | 9.611 | 8.16935 |
| 2.0228 | 9.811 | 8.33935 |
| 1.6305 | 10.361 | 8.80685 |
| 1.5921 | 10.383 | 8.82555 |
| 1.4999 | 10.43 | 8.8655 |

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims and the full scope of equivalents to which such claims are entitled. Further, it is also to be understood that the terminology used herein is for the purpose of describing particular embodiments only, and is not intended to be limiting.

With respect to the use of substantially any plural and/or singular terms herein, those skilled in the art can translate from the plural to the singular and/or from the singular to the plural as is appropriate to the context and/or application. The various singular/plural permutations may be expressly set forth herein for sake of clarity.

It will be understood by those skilled in the art that, in general, terms used herein and especially in the appended claims (e.g., the appended claims) are generally intended as “open” terms (e.g., the term “including” should be interpreted as “including but not limited to”, and the term “having” should be interpreted as “having at least”).

Furthermore, in those instances where a convention analogous to “at least one of A, B, and C, etc.” is used, in general such a construction is intended in the sense those skilled in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, and C, etc.” is used, in general such a construction is intended in the sense those skilled in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those skilled in the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, when a feature or aspect of the present disclosure is described using a Markush group, it will be understood by those skilled in the art that the present disclosure can also be described using any individual component or a sub-group of components of the Markush group.

While various embodiments of the present disclosure have been disclosed herein for purposes of illustration, it will be acknowledged that various modifications can be made without departing from the scope and spirit of the present disclosure. Therefore, the various embodiments disclosed herein are not intended to be limiting, with the true scope and spirit being indicated by the following claims.

We claim:

1. A secondary battery comprising:
an electrode assembly formed by winding an anode plate having a first uncoated region formed on one side, a cathode plate having a second uncoated region formed on the other side, and a separator disposed between the anode plate and the cathode plate;
a first current collector plate directly contacted with the first uncoated region to be electrically connected; and
a second current collector plate directly contacted with the second uncoated region to be electrically connected,
wherein the second uncoated region of the cathode plate and the first uncoated region of the anode plate are formed of the same metal material.

2. The secondary battery of claim 1,
wherein the cathode plate includes a material with a redox operating range of 1.0 V or more.

3. The secondary battery of claim 2,
wherein the cathode plate includes lithium titanium oxide (LTO).

4. The secondary battery of claim 1, further comprising:
a first insulator covering the first uncoated region and the first current collector plate; and
a second insulator covering the second uncoated region and the second current collector plate.

5. The secondary battery of claim 1,
wherein the first current collector plate and the second current collector plate are laser welded to the first uncoated region and the second uncoated region, respectively.

6. The secondary battery of claim 1,
wherein at least one of the first current collector plate and the second current collector plate has a protruding portion which is a weld point with the corresponding uncoated region.

7. The secondary battery of claim 6,
wherein the protruding portions of the first current collector plate and the second current collector plate are laser welded to the first uncoated region and the second uncoated region, respectively.

8. The secondary battery of claim 1,
wherein the first current collector plate and the second current collector plate are pressed to be contacted across the first uncoated region and the second uncoated region, respectively.

9. The secondary battery of claim 1,
wherein the first uncoated region, the second uncoated region, the first current collector plate, and the second current collector plate are formed of the same metal material.

10. The secondary battery of claim 1,
wherein the first uncoated region and the second uncoated region are formed of aluminum.

11. A secondary battery comprising:
an electrode assembly formed by winding an anode plate having an uncoated region formed on one side, a cathode plate having an uncoated region formed on the other side, and a separator disposed between the anode plate and the cathode plate; and
two or more current collector plates directly contacted with the uncoated region of the anode plate or the cathode plate to be electrically connected,
wherein each of the two or more current collector plates are pressed to be contacted across the uncoated region of the anode plate or the cathode plate.

12. A secondary battery comprising:
an electrode assembly formed by winding an anode plate having an uncoated region formed on one side, a cathode plate having an uncoated region formed on the other side, and a separator disposed between the anode plate and the cathode plate; and
two or more current collector plates directly contacted with the uncoated region of the anode plate or the cathode plate to be electrically connected,
wherein the uncoated regions of the anode plate and the cathode plate are aluminum-uncoated regions and each of the two or more current collector plates is an aluminum current collector plate, and
the cathode plate includes a material with a redox operating range of 1.0 V or more.

13. A cylindrical lithium secondary battery comprising:
an electrode assembly formed by winding an anode plate having an aluminum-uncoated region formed on one side, a cathode plate having an aluminum-uncoated region formed on the other side, and a separator disposed between the anode plate and the cathode plate; and
a set of current collector plates including two or more aluminum current collector plates directly contacted with the uncoated region of the anode plate or the cathode plate to be electrically connected,
wherein the two or more aluminum current collector plates are laser welded to the aluminum-uncoated region of the anode plate or the cathode plate, and
the cathode plate includes a material with a redox operating range of 1.0 V or more.

14. The cylindrical lithium secondary battery of claim 13,
wherein the two or more aluminum current collector plates have protruding portions which are weld points with an uncoated region.

15. The cylindrical lithium secondary battery of claim 13,
wherein the cathode plate includes lithium titanium oxide (LTO).
